(19) United States
(12) Patent Application Publication
(10) Pub. No.: US 2006/0009962 A1
(43) Pub. Date: Jan. 12, 2006

(54) Code conversion using parse trees

(75) Inventor: David Monk, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/888,118

(22) Filed: Jul. 9, 2004

(51) Int. Cl. G06F 17/28

(52) U.S. Cl. 704/4

(57) ABSTRACT

A parse tree code converter converts code using mark-up language representation of parse tress. Code from a source file that is written using, for example, a legacy language is converted into a parse tree. The parse tree can be written into a mark-up language (such as XML). The mark-up language version of the parse tree can be compiled into, for example, a more recently defined language.

### BACKGROUND OF THE INVENTION

Computer systems are important tools used by various people in many different ways. Computer applications are executed on the computer systems. These computer applications are software programs, typically written by application developers, compiled into object code, and then stored on the various computer systems for operation. The creation and use of computer applications is a well-known aspect of computer technology in general.

When creating a computer application, the developer typically chooses a particular environment or platform on which the application will ultimately be executed. For example, when writing an application, the developer will choose the Microsoft Windows® platform, the Linux platform, or some other platform. As a result of this choice, the program developer may have different options available for writing the application.

Over time, both the computing platforms and the compilers used to compile the software programs have become more sophisticated and powerful. Additionally, new languages have been developed that are more useful for writing the increasingly more complicated computer applications, while older languages (such as FORTRAN, and even some of the languages that have been used to replace FORTRAN itself) are no longer being used by most programmers to write computer applications.

Accordingly a large base of legacy code exists that is used and is becoming more difficult to maintain as programmers use more modern and sophisticated languages.

Additionally, many programmers (for a variety of reasons, such as lack of time) have not developed an ability to program in various new languages and programming facilities that are being brought on line. This creates a problem for programmers who need to quickly code in the new languages.

### SUMMARY OF THE INVENTION

The present invention is directed towards code conversion using a mark-up language, for example, representation of parse tress. Code from a source file that is written using, for example, a legacy language is converted into a parse tree. The parse tree can be written into a mark-up language (such as XML). The mark-up language version of the parse tree can be compiled into, for example, a more recently defined language.

According to one aspect of the invention, A method for converting code written in a first arbitrary computer language comprises generating a parse tree in response to source code that is written using the first arbitrary computer language; representing the parse tree using a standardized computer language such that the represented parse tree comprises a representation of intent that is inherent in the source code that is written using the first arbitrary computer language; and generating code in a target language in response to the represented parse tree such that the generating code comprises a representation of the intent that is inherent in the source code that is written using the first arbitrary computer language.

According to another aspect of the invention, a parse tree code conversion system comprises a parse tree constructor that is configured to generate a parse tree in response to source code that is written using a first arbitrary computer language and to represent the parse tree using a standardized computer language such that the represented parse tree comprises a representation of intent that is inherent in the source code that is written using the first arbitrary computer language; and a code generator that is configured to generate code in a target language in response to the represented parse tree such that the generating code comprises a representation of the intent that is inherent in the source code that is written using the first arbitrary computer language.

According to yet another aspect of the invention, a parse tree code conversion system comprises means for generating a parse tree in response to source code that is written using the first arbitrary computer language; means for representing the parse tree using a standardized computer language such that the represented parse tree comprises a representation of intent that is inherent in the source code that is written using the first arbitrary computer language; and means for generating code in a target language in response to the represented parse tree such that the generating code comprises a representation of the intent that is inherent in the source code that is written using the first arbitrary computer language.

According to a further aspect of the invention, a computer-readable medium having computer-executable components for converting code written in a first arbitrary computer language comprises instructions for: generating a parse tree in response to source code that is written using the first arbitrary computer language; representing the parse tree using a standardized computer language such that the represented parse tree comprises a representation of intent that is inherent in the source code that is written using the first arbitrary computer language; and generating code in a target language in response to the represented parse tree such that the generating code comprises a representation of the intent that is inherent in the source code that is written using the first arbitrary computer language.

### BRIEF DESCRIPTION OF THE DRAWINGS

FIG. 1 illustrates an exemplary computing device that may be used in one exemplary embodiment of the present invention.

FIG. 2 is a top-level block diagram, in accordance with aspect of the present invention.

FIG. 3 illustrates of a process 300 flow of a parse tree code converter, in accordance with aspects of the invention.

### DETAILED DESCRIPTION OF THE PREFERRED EMBODIMENT

Throughout the specification and claims, the following terms take the meanings explicitly associated herein, unless the context clearly dictates otherwise. The terminology and interface specifications used herein are not intended to represent a particular language in which a particular object or method should be written. Rather, the terminology and interface specifications are used to describe the functionality and contents of an interface or object, such as function names, inputs, outputs, return values, and what operations are to be performed using the interface (or what operations are to be performed by the object).

Illustrative Operating Environment

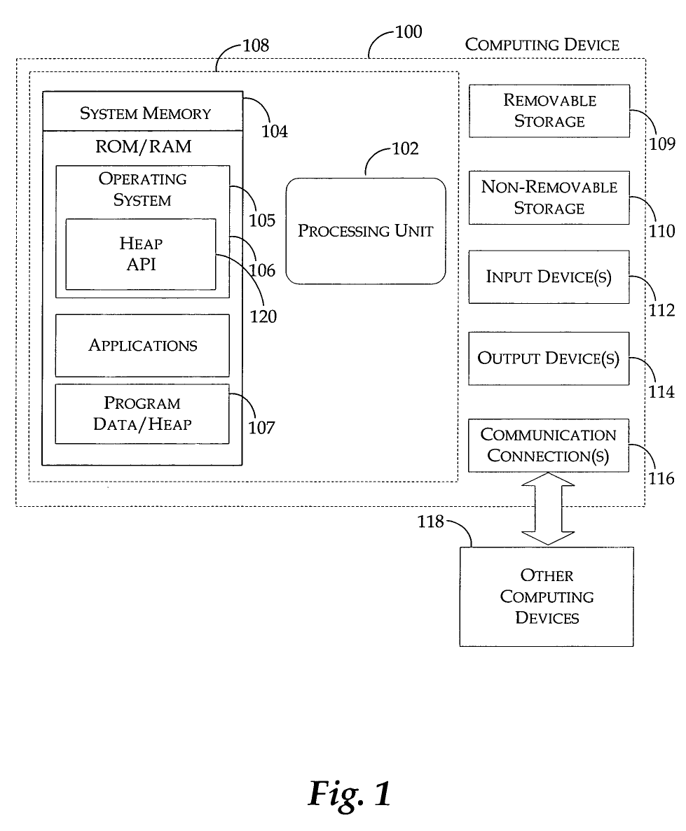

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 may include a word-processor application 120 that further includes ML editor 122. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well know in the art and need not be discussed at length here.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Code Conversion

The present invention is directed towards code conversion using mark-up language representation of parse tress. Code from a source file that is written using, for example, a legacy language is converted into a parse tree. The parse tree can be written into a mark-up language (such as XML). The mark-up language version of the parse tree can be compiled into, for example, a more recently defined language.

Using, maintaining, and/or modifying legacy software is becoming more difficult. The difficulty is due, at least in substantial part, to a large amount of legacy software that currently exists, as well as the relative lack of programmers that have experience in writing and maintaining the legacy software.

Additionally, new languages with more powerful features are continually being proposed. Often, programmers are required to use, maintaining, or modify software source code that has been written in a new language when the programmers are unfamiliar and unskilled in the new language.

The older languages (such as Pascal) that have been used for writing legacy software are often easier for programmers to use for coding because the languages are typically defined by a rigid syntax. These “simpler” languages typically lack the performance and/or reliability features that are present in more “advanced” languages (such as C++ or C#).

In accordance with present invention, a parse tree is constructed using a source file written in a simpler language. The parse tree can be represented using a markup language such as XML, which provides intermediate storage for the parse tree.

The parse tree is converted from its intermediate storage formed into a target language source file. The target language is typically a more advanced language or programming facilities such as .NET. The source file can be compiled by any suitable compiler for the target language.

Use of XML, for example, allows for a standard syntax for the intermediate storage of the parse tree. The use of a standard syntax for the intermediate storage allows for a single language converter to be written for each language into which the parse tree is to be transformed.

It will be appreciated that the “simpler” and more “advanced” language types are relatively arbitrary. For example, the “simpler” language type of the source file might be replaced with a more “advanced” language type. It will also be appreciated that the more “advanced” language type of the target language source file may be replaced with a “simpler” language type. The language types are relatively arbitrary in that a reliable parse tree constructor should exist for the particular language of the source file, and a reliable language converter should exist for the particular language of the target language source file.

Accordingly, the intent contained in legacy code can be automatically translated into parse trees (in an intermediate form such as XML). The parse trees can then be converted into source files written in a modern (target) language, with which a relatively larger number of programmers can use without having to learn the syntax of the legacy code.

Additionally, programmers of certain languages (such as those used to write the legacy code) can write source code to a language with which they are familiar. The source code can parsed, and then converted into a source file of the target language with which the programmers are not necessarily able to use. This enables programmers to code software using a more convenient language and to convert the software into, for example, more advanced languages, which allows the program to benefit from the inherent strengths of the more advanced languages.

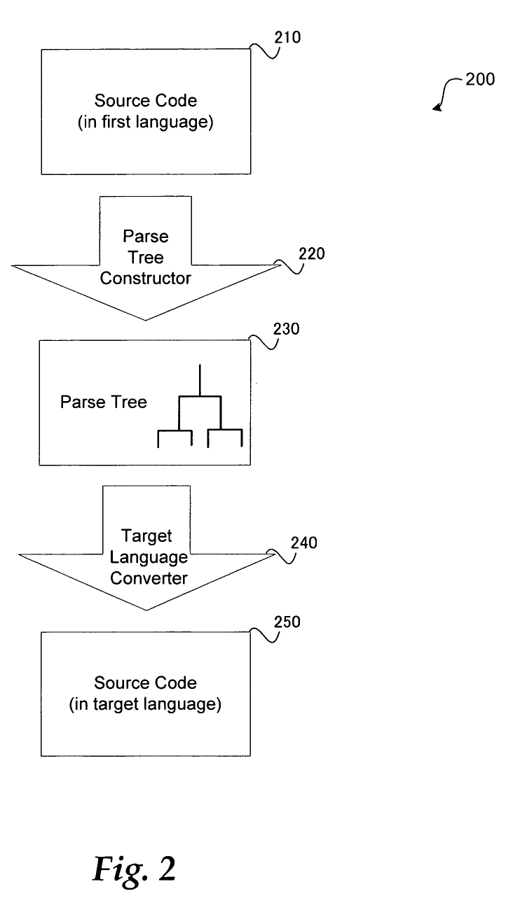

FIG. 2 is a top-level block diagram, in accordance with aspect of the present invention. The figure illustrates an original source code file (210), a parse tree constructor (220), a parse tree (230), a target language converter (240), and target source code (250). The source code file can be written, for example, using a legacy and/or a “simpler” language. Additionally, the source code file can be written, for example, using a language that is familiar to a contemporary programmer, as described above.

Parse tree constructor 220 can be any parsing tool that is suitable for generating a parse tree in response to a source file that is written according to a defined syntax. For example, a lexical analyzer (such as “lex”) and a “compiler compiler” (such as “yacc”) can be used to construct the parse tree.

Parse tree constructor 220 is used to determine the intent of source code file 210 and to construct a parse tree in accordance with the determined intent. For example, the intent to iterate (for a total of six times) the procedure “stuff” in Pascal can be expressed as follows:
for x:=0 to 5 do stuff( );
Likewise, the same intent can be expressed in C++ as:
for (x=0; x<=5; x++) stuff( );

The parse tree (230) can exist in any form that is suitable for accurately representing the intent encoded within the source file. For example, the intent expressed above in Pascal (as well as also for the C++ example above) can be expressed in XML as:

<For INITtype = integer
INITvalue = 0
LIMITtype = integer
LIMITvalue = 5/>

Accordingly, parse trees that are identical (or substantially similar) can be constructed to preserve the intent of a source code file that is written in an arbitrary language. The parse trees are substantially similar when the parse trees are converted (as described below) into a form that is functionally similar and/or accomplishes the intent encoded within the original source file.

Target language converter 240 is used to convert a parse tree (230) into a target language source code file (250). The conversion of the parse tree into a target language source code can be performed using, for example, conventional compiler technology.

As described above, the target language can be a more advanced language that has enhanced features and increased reliability. However, the target language can be any language, including the same (or similar) language as a language in which the original source code file was written. When the target language is the same (or similar) as the original source language, the original source code file can be compared with the target language source code file to validate (and/or debug) the parse tree construction and target language conversion process

In various embodiments, the target language converter can be arranged to further (or otherwise) compile information derived from the parse tree and express the compiled information as, for example, machine code for execution on a native processor.

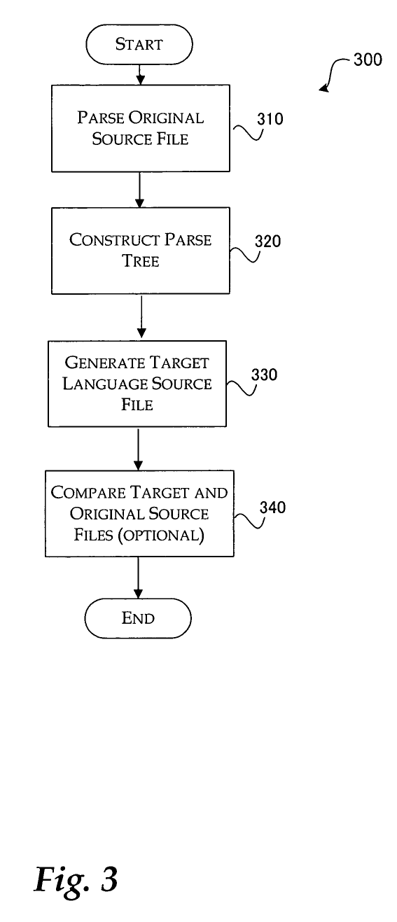

FIG. 3 illustrates of a process 300 flow of a parse tree code converter, in accordance with aspects of the invention. Process flow 300 advances to block 310 where source code that is written in a first language is parsed according to the syntax of the first language. The first language may be any computer language provided a parser exists for the first language. The process flow proceeds to block 320.

In block 320, a parse tree is constructed in response to the parsing performed in block 310. The constructed parse tree represents the intent of the programmer as encoded in the original source code. The parse tree is encoded using a standard language such as XML. The use of a standard language for the parse tree reduces the number of types of parsers and language converters that would otherwise be necessary to convert source code in an arbitrary language to a parse tree and to convert the parse tree into any number of arbitrary target languages. The process flow proceeds to block 330.

In block 330, the parse tree (constructed using a standardized language in block 320) is used to generate, for example, source code in the target language. The target language can be any arbitrary language including machine code.

Additionally, the compatibility of languages can be verified. For example, an original source code file written in a first language (e.g., ANSI C) may encounter difficulties when being converted to a target language that is based on a programming language that is very dissimilar (e.g., ML, or “Meta-Language”). The process can return information to a supervisory process, wherein the information reflects the relative similarities of the languages and, for example, whether the conversion can be accomplished reliably. The process flow optionally proceeds to block 340.

In block 340, the results of the parse tree code converter can be evaluated. When the target language is the same as (or similar to) the first language, the “text” of the original source code can be compared with the “text” of the code produced in block 330. (The “text” can be any tangible form in which the code is expressed). When the text is substantially similar The target language is substantially similar to the first language when the preservation of intent in the generated code can be determined by comparing the generated code with the original source code.

The source code and the produced code can also be evaluated by simulating, emulating, and/or executing (“executing”) the code and comparing results to determine whether the original intent has been sufficiently preserved in the generated code.

The above specification, examples and data provide a complete description of the manufacture and use of the composition of the invention. Since many embodiments of the invention can be made without departing from the spirit and scope of the invention, the invention resides in the claims hereinafter appended.

I claim:

1. A method for converting code written in a first arbitrary computer language, comprising:
generating a parse tree in response to source code that is written using the first arbitrary computer language;
representing the parse tree using a standardized computer language such that the represented parse tree comprises a representation of intent that is inherent in the source code that is written using the first arbitrary computer language; and
generating code in a target language in response to the represented parse tree such that the generating code comprises a representation of the intent that is inherent in the source code that is written using the first arbitrary computer language.

2. The method of claim 1, wherein the standardized computer language is a markup language.

3. The method of claim 1, wherein the standardized computer language is XML.

4. The method of claim 1, wherein the target language is an arbitrary computer language.

5. The method of claim 1, wherein the target language is substantially similar to the first arbitrary computer language.

6. The method of claim 6, further comprising evaluating the generated code by comparing the generating code with the source code that is written using the first arbitrary computer language.

7. The method of claim 1, further comprising evaluating the generated code by executing the generated code to generate a first set of results, and executing the source code that is written using the first arbitrary computer language to produce a second set of results, and comparing the first set of results with the second set of results.

8. A parse tree code conversion system, comprising:
a parse tree constructor that is configured to generate a parse tree in response to source code that is written using a first arbitrary computer language and to represent the parse tree using a standardized computer language such that the represented parse tree comprises a representation of intent that is inherent in the source code that is written using the first arbitrary computer language; and
a code generator that is configured to generate code in a target language in response to the represented parse tree such that the generating code comprises a representation of the intent that is inherent in the source code that is written using the first arbitrary computer language.

9. The system of claim 8, wherein the standardized computer language is a markup language.

10. The system of claim 8, wherein the standardized computer language is XML.

11. The system of claim 8, wherein the target language is an arbitrary computer language.

12. The system of claim 8 wherein the target language is substantially similar to the first arbitrary computer language.

13. The system of claim 12, further comprising an evaluator that is configured to evaluate the generated code by comparing the generating code with the source code that is written using the first arbitrary computer language.

14. The system of claim 8, further comprising an evaluator that is configured to evaluate the generated code by executing the generated code to generate a first set of results, and executing the source code that is written using the first arbitrary computer language to produce a second set of results, and comparing the first set of results with the second set of results.

15. A parse tree code conversion system, comprising:
means for generating a parse tree in response to source code that is written using the first arbitrary computer language;
means for representing the parse tree using a standardized computer language such that the represented parse tree comprises a representation of intent that is inherent in the source code that is written using the first arbitrary computer language; and
means for generating code in a target language in response to the represented parse tree such that the generating code comprises a representation of the intent that is inherent in the source code that is written using the first arbitrary computer language.

16. The system of claim 15, wherein the standardized computer language is a markup language.

17. The system of claim 15, wherein the standardized computer language is XML.

18. The system of claim 15, wherein the target language is an arbitrary computer language.

19. The system of claim 15, wherein the target language is substantially similar to the first arbitrary computer language.

20. The system of claim 19, further comprising means for evaluating the generated code by comparing the generating code with the source code that is written using the first arbitrary computer language.

21. The system of claim 15, further comprising means for evaluating the generated code by executing the generated code to generate a first set of results, and executing the source code that is written using the first arbitrary computer language to produce a second set of results, and comparing the first set of results with the second set of results.

22. A computer-readable medium having computer-executable components for converting code written in a first arbitrary computer language, comprising instructions for:
generating a parse tree in response to source code that is written using the first arbitrary computer language;
representing the parse tree using a standardized computer language such that the represented parse tree comprises a representation of intent that is inherent in the source code that is written using the first arbitrary computer language; and
generating code in a target language in response to the represented parse tree such that the generating code comprises a representation of the intent that is inherent in the source code that is written using the first arbitrary computer language.

23. The medium of claim 22, wherein the standardized computer language is a markup language.

24. The medium of claim 22, wherein the standardized computer language is XML.

25. The medium of claim 22, wherein the target language is an arbitrary computer language.

26. The medium of claim 22, wherein the target language is substantially similar to the first arbitrary computer language.

27. The medium of claim 26, further comprising instructions for evaluating the generated code by comparing the generating code with the source code that is written using the first arbitrary computer language.

28. The medium of claim 22, further comprising instructions for evaluating the generated code by executing the generated code to generate a first set of results, and executing the source code that is written using the first arbitrary computer language to produce a second set of results, and comparing the first set of results with the second set of results.

29. The medium of claim 22, further comprising instructions for evaluating the compatibility of the first language with the target language.
